(19) United States
(12) Patent Application Publication
(10) Pub. No.: US 2005/0283654 A1
(43) Pub. Date: Dec. 22, 2005

(54) Method and apparatus for decreasing failed disk reconstruction time in a raid data storage system

(75) Inventors: Robert B. Wood, Niwot, CO (US); Charles D. Kunzman, Oakland, CA (US)

Correspondence Address: KUDIRKA & JOBSE, LLP, ONE STATE STREET, SUITE 800, BOSTON, MA, 02109, US

(73) Assignee: Sun Microsystems, Inc., Santa Clara, CA (US)

(21) Appl. No.: 10/852,639

(22) Filed: May 24, 2004

(51) Int. Cl. G06F 11/00

(52) U.S. Cl. 714/7

(57) ABSTRACT

Failed disk reconstruction time in a RAID storage system is decreased when dealing with non-catastrophic disk failures by using conventional parity reconstruction to reconstruct only that part of the disk that actually failed. The non-failed remainder of the failed disk is reconstructed by simply copying the good parts of the failed disk to the reconstructed copy. Since the good parts of the failed disk are simply copied, it is possible to reconstruct a failed disk even in the presence of disk failures in the secondary volumes. The copying and reconstruction starts at the stripe level, but may be carried out at the data block level if a reconstruction error occurs due to secondary media errors.

### FIELD OF THE INVENTION

This invention relates to data storage systems, in particular, to storage systems using a Redundant Array of Independent Drives (RAID), to fault recovery in RAID storage systems and to methods and apparatus for decreasing the time required to reconstruct data on a failed disk drive in such systems.

### BACKGROUND OF THE INVENTION

Data storage systems for electronic equipment are available in many configurations. One common system is called a RAID system and comprises an array of relatively small disk drives. Data storage in the array of drives is managed by a RAID controller that makes the disk array appear to a host as a single large storage volume. RAID systems are commonly used instead of large single disks both to decrease data storage time and to provide fault tolerance.

Data storage time can be decreased In a RAID system by simultaneously storing data in parallel in all of the drives in the array. In particular, in order to store the data in parallel, a data record is broken into blocks and each block is stored in one of the drives in the array. Since the drives are independent, this latter storing operation can be carried out in parallel in all of the drives. This technique is called “striping” since the data blocks in the record look like a “stripe” across the drives.

Fault tolerance is provided by adding parity calculations to the data storing operation. For example, in a striped RAID system, the data blocks that are stored in the drives as part of a stripe can be used to calculate a parity value, generally by bitwise exclusive-ORing the data blocks in the stripe. In order to store the calculated parity value, one or more parity drives can be added to a set of drives to create a RAID volume. Alternatively, the parity value can also be striped across the drives. If the data in one of the data blocks degrades so that it cannot be read, the data can be recovered by reading the other drives in the volume (called secondary drives) and bitwise exclusive-ORing the retrieved blocks in the stripe with the parity value. When a parity drive is not explicitly described herein, the term “secondary drives” is used herein to refer both to drive configurations that include a separate parity drive and to drive configurations where the parity information is spread across the data drives.

Consequently, if a drive in the RAID volume fails, the data resident on it can be reconstructed using the secondary drives in the RAID volume, including the parity drives. Modern RAID schemes often employ spare drives, so that when a drive fails, reconstruction algorithms can recreate an image of the entire failed drive by reading the secondary drives of the RAID volume, performing the required calculations and then copying the reconstructed image to the spare drive. The spare drive is then “promoted” into the RAID set by substituting it for the failed drive in order to bring the storage volume back to the original level of redundancy enjoyed before the initial drive failure.

In practice, there are variations on the number of drives in a RAID volume, whether parity is used or not and the block size into which the data records are broken. These variations result in several RAID types, commonly referred to as RAID 0 through RAID 5. In addition, the number of parity drives in a RAID volume and the number of spare drives available for use by a particular volume can also be varied.

A typical RAID storage system 100 is illustrated in FIG. 1. This system includes a RAID volume consisting of four data drives 102-108 and a single parity drive 110. The parity information can also be spread across all of the drives 102-110. Each of drives 102-110 is shown illustratively divided into five stripes (stripe0-stripe 4.) In turn, each stripe is comprised of four data portions and one parity block. For example, stripe0 is comprised of data portions A0-D0 and parity block 0 Parity. Similarly, stripe1 is comprised of data portions A1-D1 and parity block 1 parity. Each data portion may be comprised of one or more data blocks. The number of stripes, the number of data blocks in each data portion and the size of the data blocks varies from storage system to storage system. In FIG. 1 spare drives are not shown, but would generally be part of the RAID system.

The act of reconstructing a failed drive involves many read operations and at least one write operation. For example, as discussed above, in a RAID 5 system, the blocks associated with the RAID stripe are read from each of the surviving secondary drives and the bitwise exclusive-OR algorithm is applied to create the blocks to be written to the spare drive. Hence, in a RAID set composed of N+1 drives, reconstruction involves N distinct read operations on each of N surviving drives (N+1−1) and one write operation to the spare drive to reconstruct a stripe, for a total of N+1 data transfers per stripe. Since the entire failed drive is reconstructed, many stripes may have to be copied.

In certain topologies, such as those implemented in Fibre-Channel Arbitrated Loops (FCALs), for example, the drives in a RAID volume may share the bandwidth of the I/O channel. A typical FCAL operates at two gigabit per second. Thus, a theoretical maximum reconstruction rate in this instance, ignoring any other performance bottlenecks or additive components, such as the exclusive-OR operation necessary for reconstruction, is 2 gigabits per second divided by N+1. Since most customers expect that the storage system will continue to serve application I/O workload during RAID reconstruction, achievement of this theoretical maximum is further constrained by normal system workload. The total reconstruction time is also scaled linearly by the size of the disk being reconstructed. With disk density increasing at 60-100% annually, and disk bandwidth increasing around 25%, the total reconstruction time can be expected to increase rapidly.

The net effect is that a reconstruction process may take a long time, and this time will continue to increase. During reconstruction, data on the RAID volume may be at risk should an additional disk fail. For example, in the aforementioned RAID 5 system with N+1 drives, RAID 5 protection only extends to a single drive failure. If a second drive fails during reconstruction, the missing data cannot be reconstructed and there exists a potential for a high degree of data loss.

There are various prior art schemes to minimize the exposure or loss associated with dual-drive failures, including the use of backup and restore applications, additional layers of redundancy in data sets (with consequent loss of effective capacity), duplex copy or forked writes, advanced RAID concepts and so forth. However, none of these schemes address the issue of reducing reconstruction time or exposure due to multiple drive failures.

Therefore, there is a need to reduce the reconstruction time of failure tolerant storage systems.

### SUMMARY OF THE INVENTION

In accordance with the principles of the present invention, failed disk reconstruction time in a RAID storage system is decreased in non-catastrophic disk failures by using conventional parity reconstruction to reconstruct only that part of the disk that actually failed. The non-failed remainder of the failed disk is reconstructed by simply copying the good parts of the failed disk to the reconstructed copy. Since the good parts of the failed disk are simply copied, it is possible to reconstruct a failed disk even in the presence of disk failures in the secondary volumes.

In one embodiment, data stripes that contain unreadable data from the failed disk are reconstructed by using parity reconstruction. The remainder of the failed disk is copied to the reconstructed disk.

In still another embodiment, if an attempt at parity reconstruction of a data stripe containing a failed portion fails due to a failure on another drive in the RAID set, then data block-by-data block reconstruction is attempted. Each block which is successfully read from the failed drive is copied to the reconstructed drive. Each block in which an unrecoverable read error occurs is parity reconstructed from corresponding blocks on the secondary drives in the RAID set.

In yet another embodiment, selected failure status codes from a failed read operation are used to trigger a reconstruction operation in accordance with the principles of the invention.

### BRIEF DESCRIPTION OF THE DRAWINGS

The above and further advantages of the invention may be better understood by referring to the following description in conjunction with the accompanying drawings in which:

FIG. 1 is a block schematic diagram of a conventional RAID storage system.

FIGS. 2A and 2B, when placed together, form a flowchart that shows the steps in an illustrative process for reconstructing a failed drive in accordance with the principles of the invention.

FIG. 3 is a block schematic diagram illustrating apparatus for reconstructing a failed drive in a RAID storage system that operates in accordance with the process shown in FIGS. 2A and 2B.

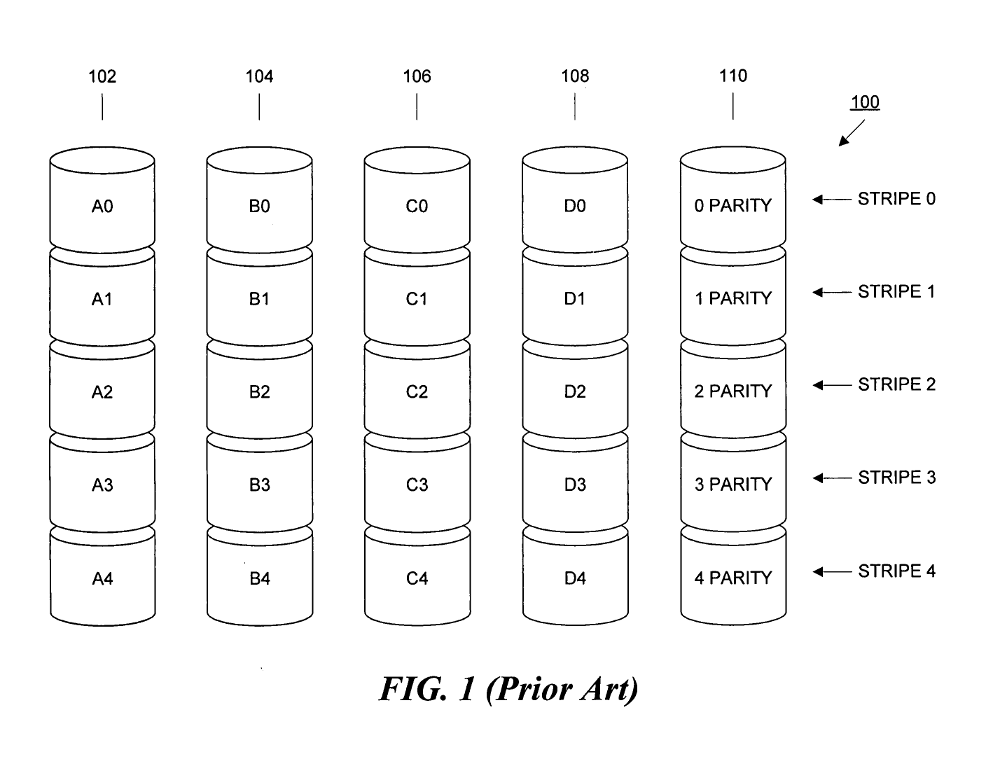

### DETAILED DESCRIPTION

In most prior art reconstruction schemes, a failed drive is taken offline, and only the surviving secondary drives are employed to create an image to be installed on the spare drive, which is then promoted. However, we have found that a significant portion, if not a majority, of disk drive failures are localized to a limited number of data blocks on magnetic media and, for example, may be due to particulate contamination, bit rot or other non-catastrophic types of failures.

If the failed drive is used as a source for at least some of the data to be written to the spare drive, for the data copied from the failed drive, the overhead associated with reading from the N surviving drives to create the data for the spare drive can be reduced to the overhead required to read from a single drive. For example, in the RAID 5 case described above, the theoretical maximum reconstruction bandwidth improves from two gigabits per second divided by N+1 to two gigabits per second divided by two.

There is generally a time cost involved in identifying failed regions on the faulty drive because, after a read to the faulty drive fails, normal parity reconstruction must still be used to reconstruct the data, thereby wasting the time spent on the failed read. In addition, depending on the nature of the failure, failed read attempts to a drive may take longer to return with an error status than standard read operations take to return with a success status. In some cases, the failed read attempts may take up to an order of magnitude (ten times) longer to return with an error status. Thus, the exact relative cost of identifying the failed regions compared to immediately issuing reads to the all of the secondary disk drives for a full parity reconstruction, depends on the size of the RAID volume. However, in most circumstances, a relatively small portion of the failed disk drive is damaged and thus incurs the identification time cost. Consequently, the identification time cost is generally small compared to the time cost of a total parity reconstruction.

For example, assume a RAID 5 volume of 5 drives, where the time cost to read one drive is x. If the worst case identification cost occurs (IOx), then the time cost in the error region is 15x (10x for the failed read to identify the region, which is wasted and then four reads to the secondary volumes (4x) and one write (1x) to the spare volume to reconstruct the data.) This time cost is 300% worse than a standard reconstruction cost of 5x. However, the time cost outside the error region is 2x, which is 40% of the standard reconstruction time. Therefore, if the failed region is 23% of the drive or less, partial copy reconstruction method will be faster than the standard pure parity reconstruction method. Typically, a failed drive region is much smaller than 23%, and RAID drive sets offer even greater savings, since the differential scales with the number of drives. This implies that partial copy reconstruction offers significant time savings over the traditional parity reconstruction. In addition, many disk drives offer bounding hints in the error status returned on a failed read, and this further reduces the total bounding cost by enabling the reconstruction process to avoid some of the reads which will fail. This effective reduction in reconstruction time reduces the window of opportunity for additional drive failures to overpower RAID protection, and reduces the performance load that reconstruction places on online storage systems.

There are additional benefits of partial copy reconstruction, including the avoidance of latent non-recoverable read errors on the N surviving drives during the reconstruction process. These read errors may not be discovered because read operations may not occur over the life of the data due to unique data access patterns, for example, in Write-Once, Read-Never (WORN) systems. In these systems, without some automated drive health testing, such latent errors can persist for long periods.

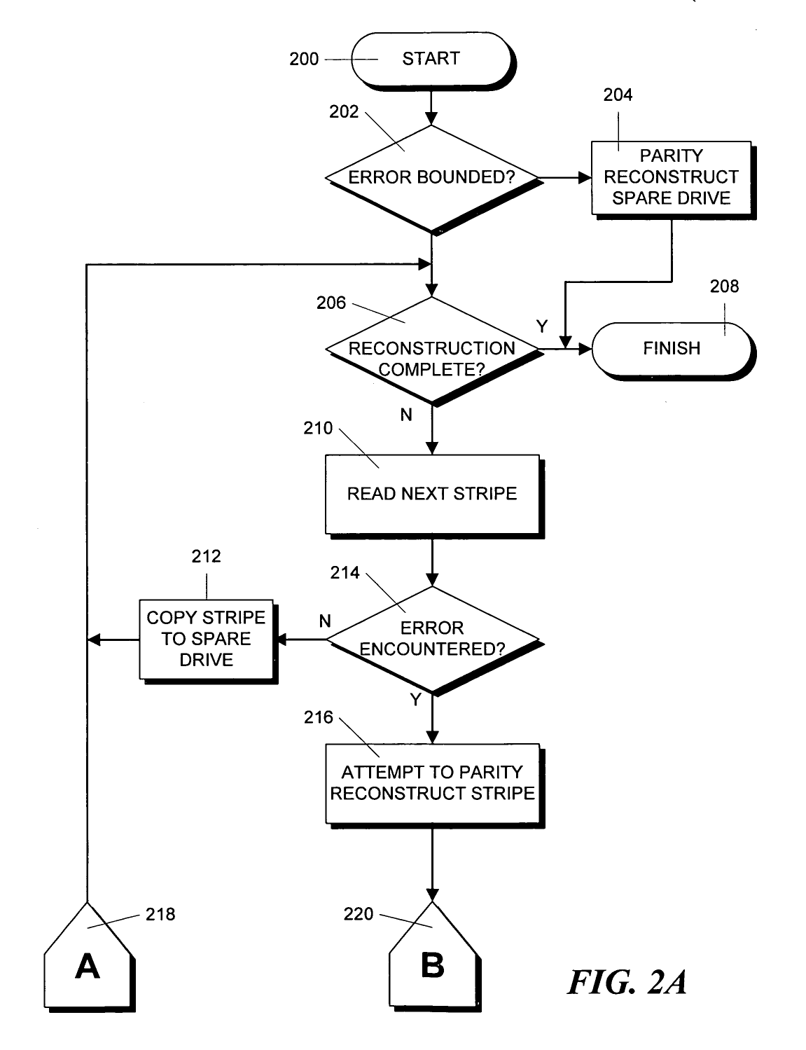

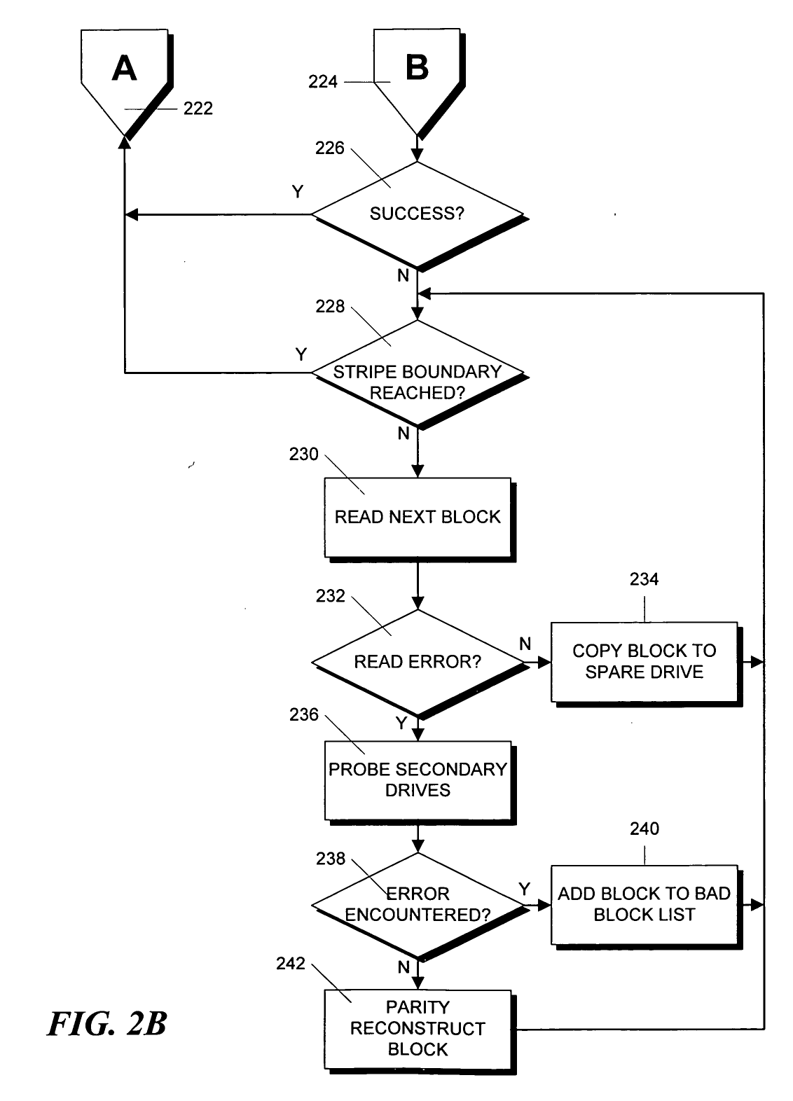

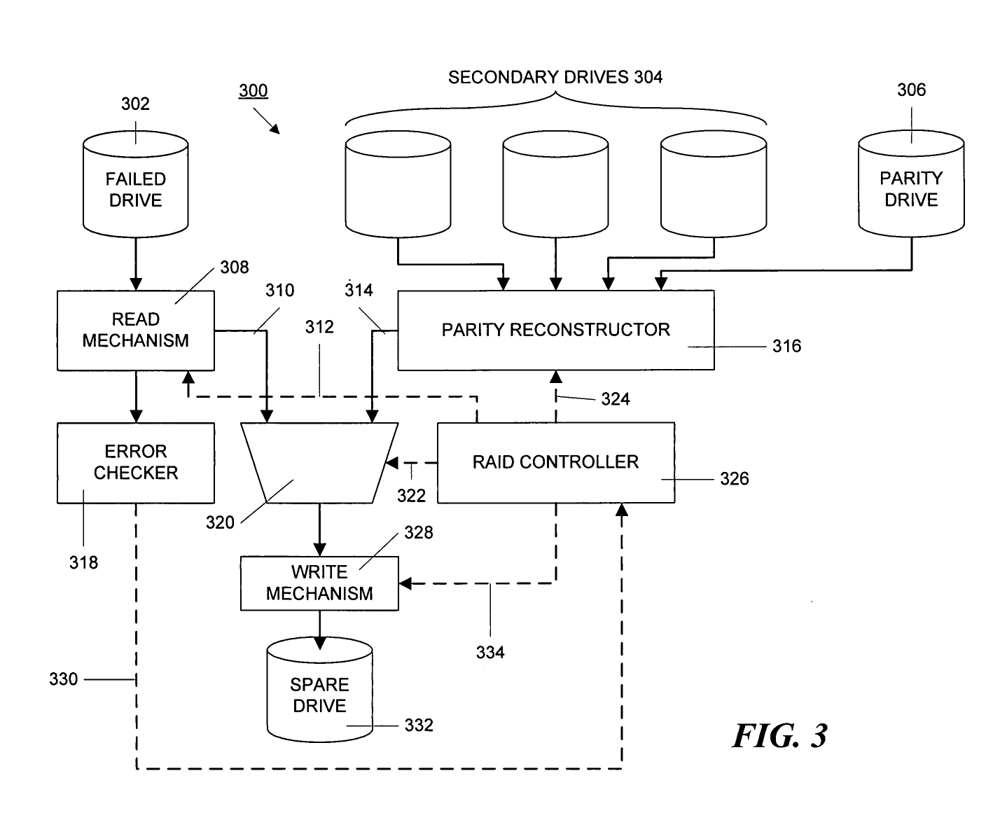

An illustrative process for reconstructing data that resides on a failed disk drive in accordance with the principles of the present invention is shown in FIGS. 2A and 2B. This process operates with an illustrative apparatus as shown in FIG. 3. The apparatus shown in FIG. 3 may reside entirely in the RAID controller 326. Alternatively, the apparatus may by part of the computer system that is controlled by hardware or firmware.

More specifically, the process is invoked when an unrecoverable read error occurs during normal I/O operations in the storage system. The process begins in step 200 and proceeds to step 202 where the controller 326 makes a determination whether the error is non-catastrophic and bounded. Generally, this determination can be made be examining error status codes produced by the error checker 318. For example, in storage systems made by Sun Microsystems, Inc., 4150 Network Drive, Palo Alto, Calif., error status codes are called SCSI sense codes. These sense codes generally consist of three hexadecimal numbers. The first number represents the sense code, the second number represents an additional sense code (ASC) and the third number represents an additional sense code qualifier (ASCQ.) These codes can be examined to determine whether the error is bounded and thus a candidate for partial copy reconstruction. Illustratively, the following sense codes could be used to trigger a partial copy reconstruction:

| Sense Code | ASC | ASCQ | Description |
|---|---|---|---|
| 0x03 | 0x03 | 0x02 | Excessive Write Errors |
| 0x04 | 0x09 | <all> | Servo Failure |
| 0x03 | 0x0c | 0x02 | Write Error - Auto Reallocation Failed |
| 0x03 | 0x0c | 0x08 | Write Error - Recovery Failed |
| 0x03 | 0x0c | 0x00 | Write Error |
| 0x03 | 0x32 | 0x00 | No Defect Spare Location Available |
| 0x03 | 0x32 | 0x01 | Defect List Update Failure |
| 0x01 | 0x5d | <all> | Failure Predication Threshold Exceeded |

If one of these status codes is not encountered, then the failure is catastrophic and data on the spare drive must be rebuilt using conventional parity reconstruction techniques as set forth in step 204. In this process, the controller reads the stripe data from the secondary drives 304 and the parity information from the parity drive 306 and constructs the missing stripe data using the parity reconstructor 316 as indicated by arrow 324. The portion of the reconstructed data that resided on the failed drive (generally a data block) is applied to multiplexer 320 as indicated by arrow 314. The controller controls multiplexer 320 as indicated by arrow 322 to apply the reconstructed data as indicated by arrow 321 to write mechanism 328. The controller 326 then controls write mechanism 328 as indicated by arrow 334 to write the data onto the spare drive 332 as indicated by arrow 336. This process in continued until data blocks in all stripes have been written to the spare drive 332 in accordance with the conventional process. The spare drive is then promoted and the process ends in step 208.

If, in step 202, a determination is made that the error is bounded and partial copy reconstruction can be used, the process proceeds to step 206 where a determination is made by the RAID controller 326 whether the reconstruction process has been completed. If the process has been completed, then the process finishes in step 208.

Alternatively, if the reconstruction process has not been completed as determined by controller 326, then, in step 210, the controller 326 controls the read mechanism 308 (as indicated schematically by arrow 312) to read a data block from the next data stripe from the failed disk drive 302. An error checker 318 determines if the read operation was successful and informs the controller 326 as indicated schematically be arrow 330. If no errors are encountered, as determined in step 214, then the controller 326 causes the multiplexer 320 to transfer the read results to the write mechanism 328 as indicated by arrows 310 and 321. The write mechanism then copies the data block in the data stripe to the spare drive 332 as indicated by arrow 336 and in step 212. In general, failures are dealt with on a stripe-by-stripe basis under the assumption that most failure regions will be fairly small. Accordingly, the cost of block level error identification will be high compared to a relatively quick attempt to parity reconstruct the entire stripe. The process then returns to step 206 to determine whether the reconstruction is complete.

The copy process continues in this manner from the beginning of the initial read error until the first read error occurs or until the location of a known write error is reached. Write failures must be tracked because some drives will fail during a write operation, but then successfully return data on a subsequent read to the same location. Thus, when a write error occurs, its location must be saved. To avoid data corruption, a parity reconstruction must be forced when dealing with a data block with a known previous write error. In some cases it may also be possible to force a subsequent read error if a write error occurs, for example, by deliberating corrupting the error checking codes. In this case, it would not be necessary to track write failures because a subsequent read will always fail.

Alternatively, if in step 214, the controller 326 determines that an error has occurred, then, in step 216, the controller attempts to reconstruct the stripe data using the parity reconstructor 316 as indicated by arrow 324. The reconstructed data is applied to multiplexer 320 as indicated by arrow 314. The controller controls multiplexer 320 as indicated by arrow 322 to apply the reconstructed data as indicated by arrow 321 to write mechanism 328. The controller 326 then controls write mechanism 328 as indicated by arrow 334 to write the appropriate data block from the data stripe onto the spare drive 332 as indicated by arrow 336.

The process then continues, via off-page connectors 220 and 224 to step 226 where a determination is made whether the reconstruction process has succeeded. If the stripe data was successfully reconstructed, then the process returns, via off-page connectors 222 and 218 to step 202 where the controller 326 determines whether the reconstruction process has succeeded in that all stripe data has been either copied or reconstructed. When the process is complete, the spare drive is then promoted.

If, in step 226, it is determined that the stripe reconstruction process has not succeeded, for example, due to an error in reading one of the secondary drives 304, then the controller attempts to copy or reconstruct the data block-by-block. The error checker 318 returns the first data block with an unrecoverable read error that occurs during the stripe reconstruction process. Block-by-block reconstruction starts at the boundary determined by this latter read error and proceeds to the stripe boundary. More specifically, in step 228, the controller determines whether the stripe boundary has been reached. If the stripe boundary has been reached, then the process returns, via off-page connectors 222 and 218 to step 202 where the controller 326 determines whether the reconstruction process has succeeded in that all stripe data has been either copied or reconstructed.

If, in step 228, the controller 326 determines that the stripe boundary has not been reached, then the controller reads the next data block from the failed drive 302. In step 232, the error checker 318 determines whether a read error has occurred on any data block and informs the controller 326 as indicated by arrow 330. If no read error has occurred, then the data block is transferred from the read mechanism 308 to multiplexer 320 as indicated by arrow 310 under control of the controller 326 as indicated by arrow 312. The data block is then transferred to the write mechanism 328 as indicated by arrow 321 and written to the spare drive as indicated by arrow 336 and set forth in step 234.

If, in step 232, the error checker 318 determines that a read error has occurred, then the controller 326 attempts to parity reconstruct the data block. In particular, in step 236, the controller 326 probes the secondary drives 304 and the parity drive 306 to determine whether the corresponding data block can be read from all of drives 304 and 306. If no errors are encountered as determined in step 238, the data block can be read from all drives, and then the parity reconstructor 316 is used to reconstruct the block as set forth in step 242. The data block is then written by the controller 326 to the spare drive 332 in the manner discussed above for a data stripe. Alternatively, if in step 238, an error is encountered when reading the data block from one of the drives, an attempt is made to add the data block to the list of known bad blocks.

For a full recovery, the reconstruction process must keep a block-by-block tag indicating which blocks are readable and which are not readable on the failed drive, the secondary drives and the parity drive. Once probed, individual blocks can be reconstructed so long as no two errors occur on the same block set. However, some blocks can be recovered even though data cannot be read from the secondary drives since it may be possible to read the data directly from the failed drive. In particular, the following example illustrates this.

In this example, it is assumed that the stripe size is 2 kilobytes and the storage system is a RAID 5 system with a five disk RAID volume. The example illustrates one stripe where RAID disk 0 is being reconstructed. The numbers under each disk represent one data portion, comprised of four data blocks, in the stripe that is stored on that disk. The “x” stands for blocks that are not readable. In this example, all “0” blocks belong to a parity linked set. In particular, they are only dependent on each other and not on any blocks in the parity linked sets “1”, “2” or “3”. Similarly, “1” blocks, “2” blocks and “3” blocks form parity linked sets.

| Disk 0 | Disk 1 | Disk 2 | Disk 3 |
|---|---|---|---|
| 0 1 x 3 | 0 x 2 x | 0 1 2 x | x 1 2 3 |

In this example, block 2 cannot be read from Disk 0. However, the data block that cannot be read from Disk 0 can be recovered since block 2 is available on all other disks, despite the fact that some disks have errors in other blocks. Thus, block 2 can be reconstructed from these disks using conventional parity reconstruction techniques. Note that block 3 on Disk 0 will be copied from Disk 0 to the spare disk so that the fact that it cannot be reconstructed from Disks 1-3 (due to the fact that it is unreadable on both Disk 1 and Disk 2) is not important. In addition, in situations where the data may never be read, such as the aforementioned WORN systems, the invention may prevent unnecessary device replacement.

In the algorithm discussed above, disk failures are bounded by proceeding from the first stripe to the last and reconstructing stripes, or blocks, where failures occur. However, bounding a failure may involve algorithms other than proceeding from the first stripe to the last. For example, an alternative algorithm could proceed from the first stripe until a failure is encountered and then from the last stripe backwards towards the failed stripe until the failure area is reached, such as within N stripes of the failed stripe. Alternatively, knowledge of a zone map (a mapping of logical block addresses to physical locations on the disk) might be used to test blocks physically around a failed block (on different tracks) to bound physical damage associated with head crashes that occur during a seek. A similar approach can be used for block-by-block reconstruction. In particular, blocks can be read starting at the beginning of a stripe and proceeding until an error in encountered. The reconstruction process can then read blocks starting at the stripe boundary and continuing until the error location is reached.

A software implementation of the above-described embodiment may comprise a series of computer instructions either fixed on a tangible medium, such as a computer readable media, for example, a diskette, a CD-ROM, a ROM memory, or a fixed disk, or transmittable to a computer system, via a modem or other interface device over a medium. The medium either can be a tangible medium, including but not limited to optical or analog communications lines, or may be implemented with wireless techniques, including but not limited to microwave, infrared or other transmission techniques. It may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, pre-loaded with a computer system, e.g., on system ROM or fixed disk, or distributed from a server or electronic bulletin board over a network, e.g., the Internet or World Wide Web.

Although an exemplary embodiment of the invention has been disclosed, it will be apparent to those skilled in the art that various changes and modifications can be made which will achieve some of the advantages of the invention without departing from the spirit and scope of the invention. For example, it will be obvious to those reasonably skilled in the art that, in other implementations, different methods could be used for determining whether partial copy reconstruction should begin. Other aspects, such as the specific process flow, as well as other modifications to the inventive concept are intended to be covered by the appended claims.

1. A method for decreasing a time period required to reconstruct a copy of a failed disk drive from secondary RAID drives in a RAID data storage system with a plurality of RAID drives, the method comprising:
(a) attempting to read data from the failed disk drive;
(b) when data can be read from the failed disk drive, copying that data to the copy; and
(c) when data cannot be read from the failed disk drive, reconstructing that data from the secondary RAID drives and storing the reconstructed data to the copy.

2. The method of claim 1 wherein data is stored in the RAID data storage system in parity linked data stripes in which a portion of each data stripe resides on one of the RAID drives and wherein step (a) comprises attempting to read a data stripe portion from the failed disk drive.

3. The method of claim 2 wherein step (b) comprises copying the data stripe portion to the copy.

4. The method of claim 2 wherein step (c) comprises reconstructing the data stripe portion from the secondary RAID drives.

5. The method of claim 4 wherein each data stripe portion that is stored on the plurality of RAID drives comprises a parity linked set of data blocks and wherein the method further comprises:
(d) when the data stripe cannot be reconstructed from the secondary RAID drives in step (c), attempting to read the data blocks in the data stripe portion stored on the failed drive;
(e) when a data block can be read from the failed disk drive, copying that data block to the copy; and
(f) when a data block cannot be read from the failed disk drive, reconstructing that data block from the secondary RAID drives and storing the reconstructed data block to the copy.

6. The method of claim 5 further comprising:
(g) when a data block cannot be read from the failed disk drive and cannot be reconstructed from the secondary RAID drives, adding that data block to a list of bad blocks.

7. The method of claim 5 wherein step (e) comprises copying data blocks from the failed disk drive starting at the location of an unrecoverable read error and continuing until a data stripe boundary is reached.

8. The method of claim 1 further comprising removing the failed disk drive from the plurality of RAID drives and promoting the copy into the plurality of RAID drives.

9. The method of claim 1 wherein step (b) comprises copying to the copy data from the failed drive starting at the beginning of an error that caused the failed drive to fail and continuing until an unrecoverable read error occurs.

10. The method of claim 9 wherein step (b) further comprises copying to the copy data from the failed drive starting at the beginning of an error that caused the failed drive to fail and continuing until a location of a known write failure is reached.

11. A method for decreasing a time period required to construct a data image of a failed disk drive from secondary RAID drives in a RAID data storage system with a plurality of RAID drives, wherein data is stored in the RAID data storage system in parity linked data stripes in which a portion of each data stripe resides on one of the RAID drives, the method comprising:
(a) reading a data stripe from the plurality of RAID drives;
(b) when step (a) is successful, copying a data stripe portion of that data stripe that resides on the failed drive to the data image; and
(c) when an error is encountered during step (a) reconstructing that data stripe from the secondary RAID drives and storing the data stripe portion of the reconstructed data stripe that resides on the failed drive to the data image.

12. The method of claim 11 further comprising:
(d) repeating steps (a)-(c) for each data stripe stored on the RAID drives.

13. The method of claim 12 wherein step (d) comprises reading data stripes from the plurality of RAID drives starting from a first data stripe until an error is encountered.

14. The method of claim 13 wherein step (d) further comprises, after an error is encountered, reading data stripes from the plurality of RAID drives starting from a last data stripe and proceeding backwards.

15. The method of claim 11 wherein each data stripe portion that is stored on the plurality of RAID drives comprises a parity linked set of data blocks and wherein the method further comprises:
(d) when the data stripe cannot be reconstructed from the secondary RAID drives in step (c), attempting to read the data blocks in the data stripe portion stored on the failed drive;
(e) when a data block can be read from the failed disk drive, copying that data block to the data image; and
(f) when a data block cannot be read from the failed disk drive, reconstructing that data block from the secondary RAID drives and storing the reconstructed data block to the data image.

16. The method of claim 15 further comprising:
(g) when a data block cannot be read from the failed disk drive and cannot be reconstructed from the secondary RAID drives, adding that data block to a list of bad blocks.

17. The method of claim 15 wherein step (e) comprises copying data blocks from the failed disk drive starting at the location of an unrecoverable read error and continuing until a data stripe boundary is reached.

18. The method of claim 15 wherein step (e) comprises copying data blocks from the failed disk drive starting at a data stripe boundary and continuing until the location of an unrecoverable read error is reached.

19. The method of claim 11 further comprising copying the data image onto one of the plurality of RAID drives.

20. Apparatus for decreasing a time period required to reconstruct a copy of a failed disk drive from secondary RAID drives in a RAID data storage system with a plurality of RAID drives, the apparatus comprising:
a read mechanism that attempts to read data from the failed disk drive;
a write mechanism that writes data to the copy;
a multiplexer operable when data can be read from the failed disk drive, for providing that data to the write mechanism in order to copy that data to the copy; and
a parity reconstructor operable when data cannot be read from the failed disk drive that reconstructs that data from the secondary RAID drives and provides the reconstructed data to the write mechanism in order to store the reconstructed data to the copy.

21. The apparatus of claim 20 wherein data is stored in the RAID data storage system in parity linked data stripes in which a portion of each data stripe resides on one of the RAID drives and wherein the read mechanism comprises a mechanism that attempts to read a data stripe portion from the failed disk drive.

22. The apparatus of claim 21 wherein the multiplexer comprises a mechanism that copies the data stripe portion to the copy.

23. The apparatus of claim 21 wherein the parity reconstructor comprises a mechanism that reconstructs the data stripe portion from the secondary RAID drives.

24. The apparatus of claim 23 wherein each data stripe portion that is stored on the plurality of RAID drives comprises a parity linked set of data blocks and wherein the method further comprises:
a mechanism operable when the data stripe cannot be reconstructed from the secondary RAID drives by the parity reconstructor, that attempts to read the data blocks in the data stripe portion stored on the failed drive;
a mechanism, operable when a data block can be read from the failed disk drive, that copies that data block to the copy; and
a mechanism, operable when a data block cannot be read from the failed disk drive, that reconstructs that data block from the secondary RAID drives and stores the reconstructed data block to the copy.

25. The apparatus of claim 24 further comprising:
a mechanism, operable when a data block cannot be read from the failed disk drive and cannot be reconstructed from the secondary RAID drives, that adds that data block to a list of bad blocks.

26. The apparatus of claim 24 wherein the mechanism that copies data blocks to the copy, comprises a mechanism that copies data blocks from the failed disk drive starting at the location of an unrecoverable read error and continuing until a data stripe boundary is reached.

27. The apparatus of claim 20 further comprising means for removing the failed disk drive from the plurality of RAID drives and means for promoting the copy into the plurality of RAID drives.

28. The apparatus of claim 20 wherein the mechanism that copies data blocks to the copy comprises a mechanism that copies to the copy data from the failed drive starting at the beginning of an error that caused the failed drive to fail and continuing until an unrecoverable read error occurs.

29. The apparatus of claim 28 wherein the mechanism that copies data blocks to the copy further comprises a mechanism that copies to the copy data from the failed drive starting at the beginning of an error that caused the failed drive to fail and continuing until a location of a known write failure is reached.

30. Apparatus for decreasing a time period required to construct a data image of a failed disk drive from secondary RAID drives in a RAID data storage system with a plurality of RAID drives, wherein data is stored in the RAID data storage system in parity linked data stripes in which a portion of each data stripe resides on one of the RAID drives, the apparatus comprising:
means for reading a data stripe from the plurality of RAID drives;
means operable when a data stripe can be read from the plurality of RAID drives, for copying a data stripe portion of that data stripe that resides on the failed drive to the data image; and
means operable when an error is encountered during the reading of a data stripe from the plurality of RAID drives, for reconstructing that data stripe from the secondary RAID drives and storing the data stripe portion of the reconstructed data stripe that resides on the failed drive to the data image.

31. The apparatus of claim 30 wherein the means for reading a data stripe from the plurality of RAID drives further comprises means for reading each data stripe stored on the RAID drives.

32. The apparatus of claim 31 wherein the means for reading each data stripe stored on the RAID drives comprises means for reading data stripes from the plurality of RAID drives starting from a first data stripe until an error is encountered.

33. The apparatus of claim 32 wherein the means for reading each data stripe stored on the RAID drives further comprises means operable after an error is encountered, for reading data stripes from the plurality of RAID drives starting from a last data stripe and proceeding backwards.

34. The apparatus of claim 30 wherein each data stripe portion that is stored on the plurality of RAID drives comprises a parity linked set of data blocks and wherein the apparatus further comprises:
means operable when the data stripe cannot be reconstructed from the secondary RAID drives, for attempting to read the data blocks in the data stripe portion stored on the failed drive;
means operable when a data block can be read from the failed disk drive, for copying that data block to the data image; and
means operable when a data block cannot be read from the failed disk drive, for reconstructing that data block from the secondary RAID drives and storing the reconstructed data block to the data image.

35. The apparatus of claim 34 further comprising means operable when a data block cannot be read from the failed disk drive and cannot be reconstructed from the secondary RAID drives, for adding that data block to a list of bad blocks.

36. The apparatus of claim 34 wherein the means operable when a data block can be read from the failed disk drive, for copying that data block to the data image comprises means for copying data blocks from the failed disk drive starting at the location of an unrecoverable read error and continuing until a data stripe boundary is reached.

37. The apparatus of claim 34 wherein the means operable when a data block can be read from the failed disk drive, for copying that data block to the data image comprises means for copying data blocks from the failed disk drive starting at a data stripe boundary and continuing until the location of an unrecoverable read error is reached.

38. The apparatus of claim 30 further comprising means for copying the data image onto one of the plurality of RAID drives.

39. A computer program product for decreasing a time period required to construct a data image of a failed disk drive from secondary RAID drives in a RAID data storage system with a plurality of RAID drives, wherein data is stored in the RAID data storage system in parity linked data stripes in which a portion of each data stripe resides on one of the RAID drives, the computer program product comprising a computer usable media having computer readable program code thereon, including:
program code for reading a data stripe from the plurality of RAID drives;
program code operable when a data stripe can be read from the plurality of RAID drives, for copying a data stripe portion of that data stripe that resides on the failed drive to the data image; and
program code operable when an error is encountered during the reading of a data stripe from the plurality of RAID drives, for reconstructing that data stripe from the secondary RAID drives and storing the data stripe portion of the reconstructed data stripe that resides on the failed drive to the data image.

40. A computer data signal embodied in a carrier wave for decreasing a time period required to construct a data image of a failed disk drive from secondary RAID drives in a RAID data storage system with a plurality of RAID drives, wherein data is stored in the RAID data storage system in parity linked data stripes in which a portion of each data stripe resides on one of the RAID drives, the computer data signal comprising:
program code for reading a data stripe from the plurality of RAID drives;
program code operable when a data stripe can be read from the plurality of RAID drives, for copying a data stripe portion of that data stripe that resides on the failed drive to the data image; and
program code operable when an error is encountered during the reading of a data stripe from the plurality of RAID drives, for reconstructing that data stripe from the secondary RAID drives and storing the data stripe portion of the reconstructed data stripe that resides on the failed drive to the data image.
